(19) United States
(12) Patent Application Publication
(10) Pub. No.: US 2015/0199960 A1
(43) Pub. Date: Jul. 16, 2015

(54) I-Vector Based Clustering Training Data in Speech Recognition

(71) Applicant: Microsoft Corporation, Redmond, WA (US)

(72) Inventors: Qiang Huo, Beijing (CN); Zhi-Jie Yan, Beijing (CN); Yu Zhang, Beijing (CN); Jian Xu, Beijing (CN)

(21) Appl. No.: 13/640,804

(22) PCT Filed: Aug. 24, 2012
(86) PCT No.: PCT/CN12/80527

§ 371 Date: Oct. 12, 2012

(51) Int. Cl. G10L 15/06

(52) U.S. Cl. CPC G10L 15/063; G10L 2015/0631

(57) ABSTRACT

Methods and systems for i-vector based clustering training data in speech recognition are described. An i-vector may be extracted from a speech segment of a speech training data to represent acoustic information. The extracted i-vectors from the speech training data may be clustered into multiple clusters using a hierarchical divisive clustering algorithm. Using a cluster of the multiple clusters, an acoustic model may be trained. This trained acoustic model may be used in speech recognition.

### CROSS REFERENCE TO RELATED PATENT APPLICATIONS

This application is a national stage application of an international patent application PCT/CN2012/080527, filed Aug. 24, 2012, which is hereby incorporated in its entirety by reference.

### BACKGROUND

Automatic speech recognition (ASR) converts speech into text. Using clustered training data with training acoustic models improves recognition accuracy in ASR. Recently, the training of acoustic models has attracted much attention because of the large amount of training speech data being generated from a large population of speakers in diversified acoustic environments and transmission channels. For example, the training speech data may include utterances that are spoken by various speakers with different speaking styles under various acoustic environments, collected by various microphones, and transmitted via various channels. Although available to build ASR systems, the large amount of training speech data being generated presents problems (e.g., low efficiency and scalability) for training acoustic models using in conventional speech recognition technologies.

### SUMMARY

Described herein are techniques for using clustering training data in speech recognition. An i-vector may be extracted from a training speech segment of a training data (e.g., a training corpus). The extracted i-vectors of the training data may then be clustered into multiple clusters to identify multiple acoustic conditions. The multiple clusters may be used to train acoustic models associated with the multiple acoustic conditions. The trained acoustic models may be used in speech recognition.

In some aspects, a set of hyperparameters and a Gaussian mixture model (GMM) that are associated with the training data may be calculated to extract the i-vector. In some embodiments, an additional set of hyperparameters may be calculated using a residual term to model variabilities of the training data that are not captured by the set of hyperparameters.

In some aspects, an i-vector may be extracted from an unknown speech segment. One or more clusters may be selected based on similarities between the i-vector and the one or more clusters. One or more acoustic models corresponding to the one or more clusters may then be determined. The unknown speech segment may be recognized using the one or more determined acoustic models.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative architecture for clustering training data in speech recognition.

FIG. 2 is a flow diagram of an illustrative process for clustering training data in speech recognition.

FIG. 3 is a flow diagram of an illustrative process for extracting an i-vector from a speech segment.

FIG. 4 is a flow diagram of an illustrative process for calculating hyperparameters.

FIG. 5 is a flow diagram of an illustrative process for recognizing speech segments using trained acoustic models.

FIG. 6 is a schematic diagram of an illustrative scheme that implements speech recognition using one or more acoustic models.

FIG. 7 is a block diagram of an illustrative computing device that may be deployed in the architecture shown in FIG. 1.

### DETAILED DESCRIPTION

### Overview

This disclosure is directed, in part, to speech recognition using i-vector based training data clustering. Embodiments of the present disclosure extract i-vectors from a set of speech segments in order to represent acoustic information. The extracted i-vectors may then be clustered into multiple clusters that may be used to train multiple acoustic models for speech recognition.

During i-vector extraction, a simplified factor analysis model may be used without a residual term. In some embodiments, the i-vector extraction may be extended by using a full factor analysis model with a residual term. During the speech recognition stage, an i-vector may be extracted from an unknown speech segment. A cluster may be selected based on a similarity between the cluster and the extracted i-vector. The unknown speech segment may be recognized using an acoustic model trained by the selected cluster.

Conventional i-vector based speaker recognition uses Baum-Welch statistics. But using Baum-Welch statistics renders conventional solutions unsuitable to hyperparameter estimation, due to high complexity and computational resource requirements. But embodiments of the present disclosure use novel hyperparameter estimation procedures, which are less computationally complex than conventional approaches.

### Illustrative Architecture

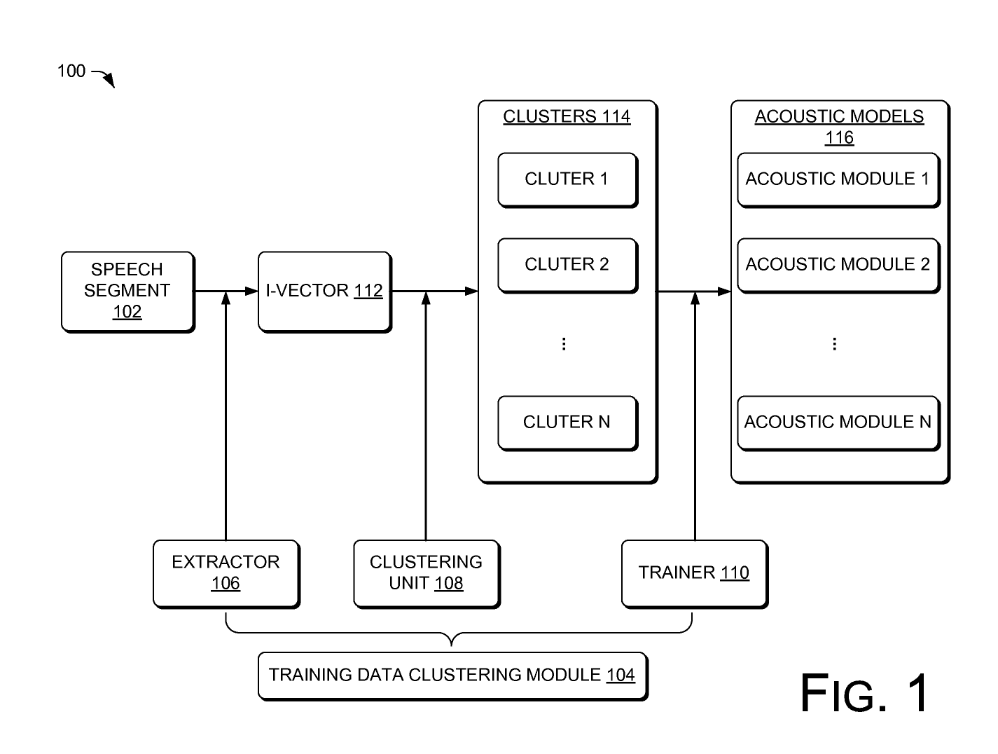

FIG. 1 is a schematic diagram of an illustrative architecture 100 for clustering training data in speech recognition. The architecture 100 includes a speech segment 102 and a training data clustering module 104. The speech segment 102 may include one or more frames of speech or one or more utterances of speech data (e.g., a training corpus). The training data clustering module 104 may include an extractor 106, a clustering unit 108, and a trainer 110. The extractor 106 may extract a low-dimensional feature vector (e.g., an i-vector 112) from the speech segment 102. The extracted i-vector may represent acoustic information.

In some embodiments, i-vectors extracted from the training corpus may be clustered into clusters 114 by the clustering unit 108. The clusters 114 may include multiple clusters (e.g., cluster 1, cluster 2 . . . cluster n). In some embodiments, a hierarchical divisive clustering algorithm may be used to cluster the i-vectors into multiple clusters.

The clusters 114 may be used to train acoustic models 116 by the trainer 110. The acoustic models 116 may include multiple acoustic models (e.g., acoustic model 1, acoustic model 2 . . . acoustic model n) to represent various acoustic conditions. In some embodiments, for each acoustic model may be trained using a cluster. After training, the acoustic models 116 may be used in speech recognition to improve recognition accuracy. The i-vector based training data clustering as described herein can efficiently handle a large training corpus using conventional computing platforms. In some embodiments, the i-vector based approach may be used for acoustic sniffing in irrelevant variability normalization (IVN) based acoustic model training for large vocabulary continuous speech recognition (LVCSR).

### Illustrative Operation

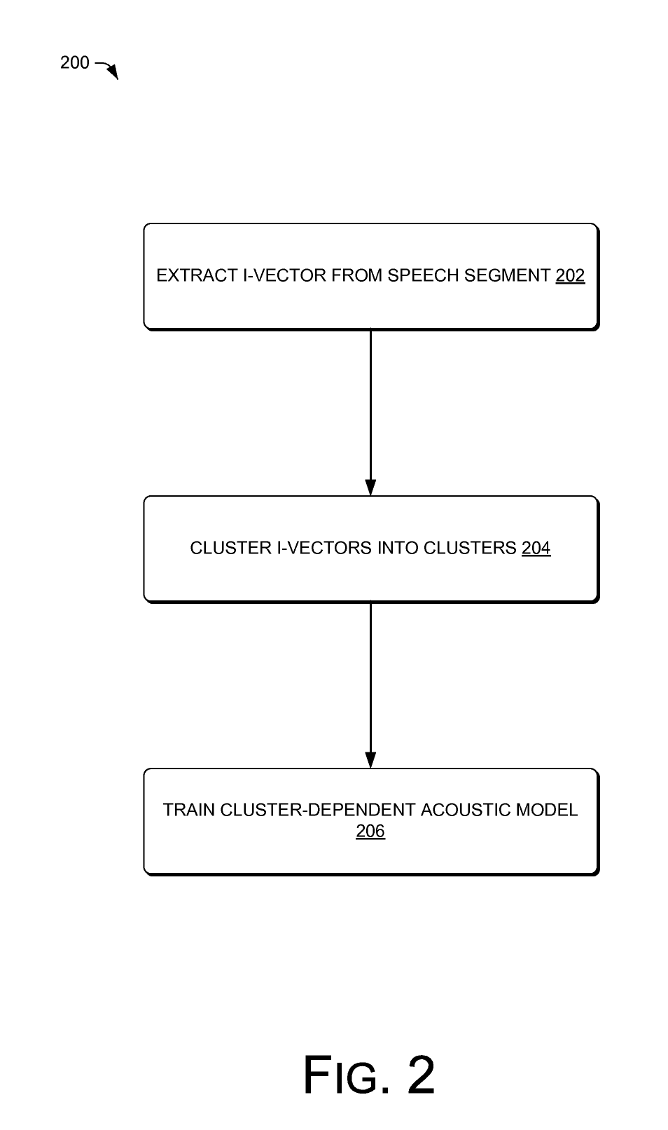

FIG. 2 is a flow diagram of an illustrative process 200 for clustering training data in speech recognition. The process 200 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, including the processes 300, 400 and 500, in addition to process 200, shall be interpreted accordingly.

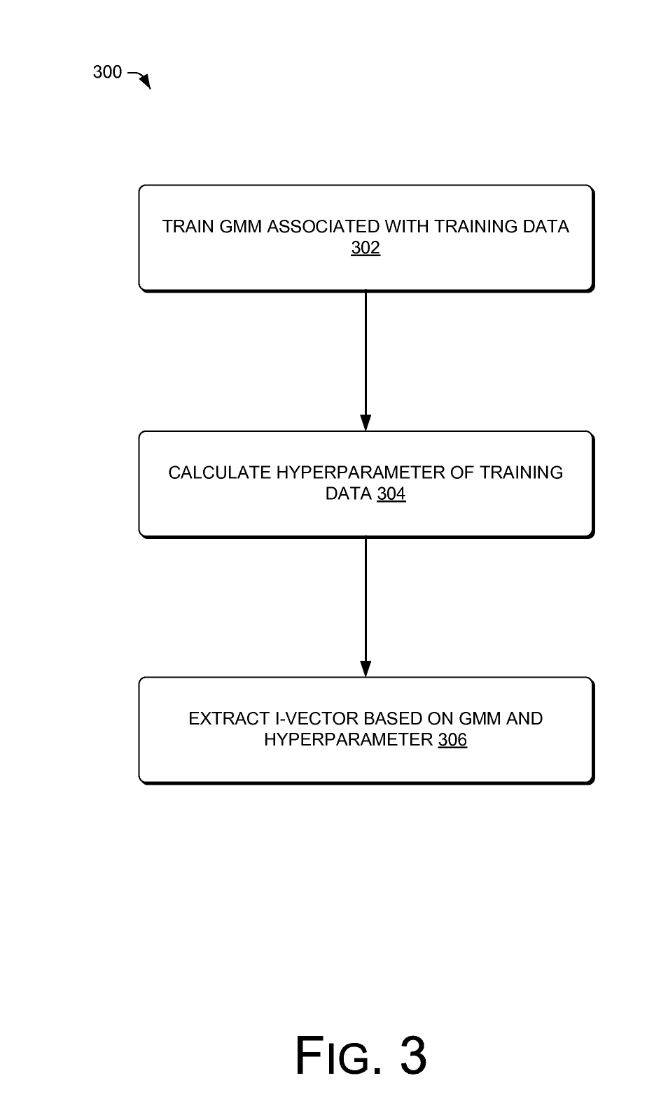

At 202, the extractor 106 may extract the i-vector 112 from the speech segment 102. The i-vector 112 includes a low-dimensional feature vector extracted from a speech segment used to represent certain information associated with speech data (e.g., the training corpus). For example, i-vectors may be extracted from the training corpus in order to represent speaker information, and the i-vector is used to identify and/or verify a speaker during speech recognition. In some embodiments, the i-vector 112 may be extracted based on a set of hyperparameters (a.k.a. a total variability matrix) estimation, which is discussed in a greater detail in FIG. 3.

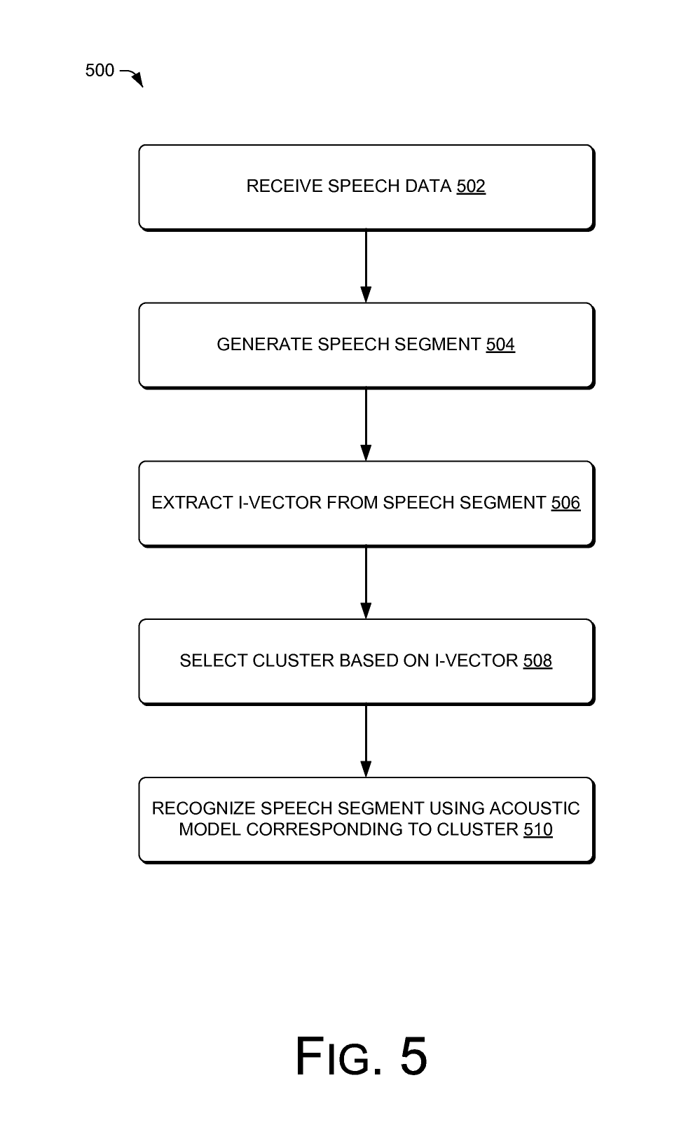

At 204, the clustering unit 108 may aggregate the i-vectors extracted from the speech data and cluster the i-vectors into the clusters 114. In some embodiments, a hierarchical divisive clustering algorithm (e.g., a Linde-Buzo-Gray (LBG) algorithm) may be used to cluster the i-vectors into the clusters. 114. Various schemes to measure dissimilarity may be used to aid in the clustering. For example, a Euclidean distance may be used to measure a dissimilarity between two i-vectors of the clusters 114. In another example, a cosine measure may be used to measure a similarity between two i-vectors of the clusters 114. If the cosine measure is used, then the i-vectors of the extracted i-vectors may be normalized to have a unit norm, and a centroid for individual ones of the clusters 114 may be calculated. Centroids of the clusters 114 may be used to identify the clusters that are most similar to the individual i-vectors extracted from an unknown speech segment, which is discussed in a greater detail in FIG. 5. Accordingly, the training speech segments may be classified into one of the clusters 114.

At 206, the trainer 110 may train the acoustic models 116 using the clusters 114. The trained acoustic models may be used in speech recognition in order to improve recognition accuracy. In some embodiments, for individual ones of the clusters 114, a cluster-dependent acoustic model may be trained by using a cluster-independent acoustic model as a seed. In these instances, the acoustic models 116 may include multiple cluster-dependent acoustic models and a cluster-independent acoustic model.

FIG. 3 is a flow diagram of an illustrative process 300 for extracting an i-vector from a speech segment. At 302, the extractor 106 may train a Gaussian mixture model (GMM) from a set of training data using a maximum likelihood approach to serve as a universal background model (UBM).

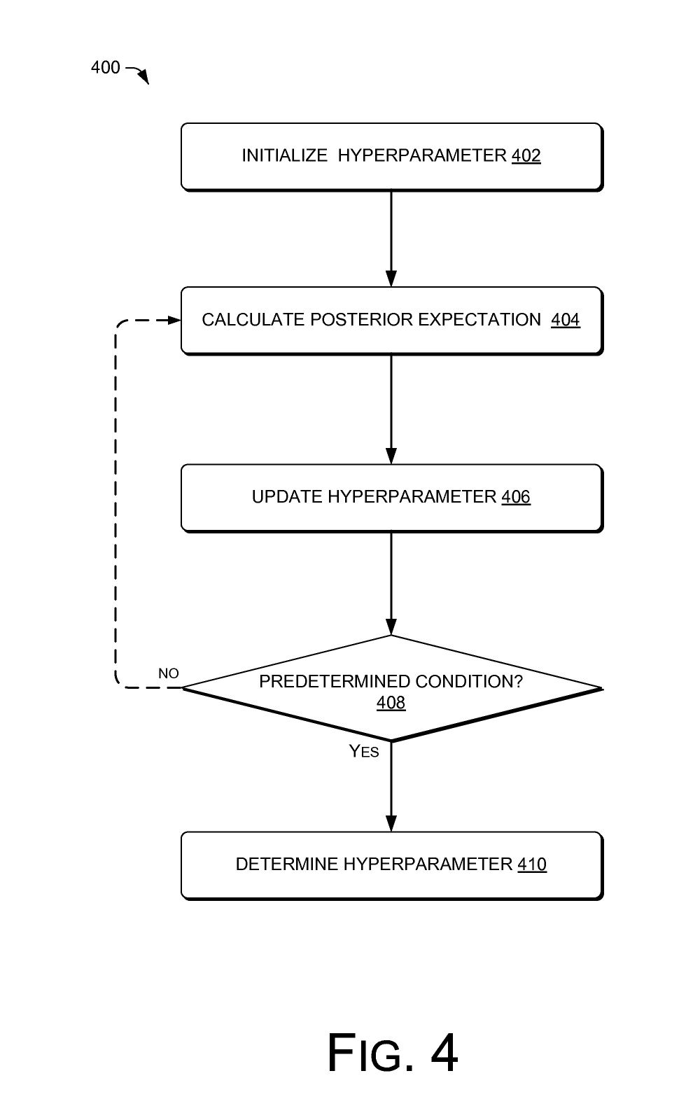

At 304, the extractor 106 may calculate a set of hyperparameters associated with the set of training data. The hyperparameter estimation procedures are discussed in a greater detail in FIG. 4.

At 306, the extractor 106 may extract the i-vector 112 from the speech segment 102 based on the trained GMM and calculated hyperparameters. In some embodiments, an additional set of hyperparameters may also be calculated using a residual term to model variabilities of the set of training data that are not captured by the set of hyperparameters. In these instances, the i-vector 112 may be extracted from the speech segment 102 based on the trained GMM, the set of hyperparameters, and the additional set of hyperparameters.

FIG. 4 is a flow diagram of an illustrative process 400 for calculating hyperparameters. In some embodiments, an expectation-maximization (EM) algorithm may be used to hyperparameter estimation. In these instances, initial values of the elements of the hyperparameters of the set of training data may be set at 402. For individual ones of the training segments of the training data, corresponding “Baum-Welch” statistics may be calculated. At 404, for individual ones of the training segments, a posterior expectation may be calculated using the sufficient statistics and a current hyperparameter. At 406, the hyperparameters may be updated based on the posterior expectation.

At 408, if an iteration number of the hyperparameter estimation is greater than a predetermined number or an objective function converges (i.e., branch of “Yes”), then the hyperparameters for i-vector extraction may be determined at 408. The objective function may be maximized during the hyperparameter estimation. If the iteration number is less than or equal to the predetermine number or the objective function has not converged (i.e., branch of “No”), the operations 404 to 408 may be performed by a loop process (see the dashed line from 408 that leads back to 404).

FIG. 5 is a flow diagram of an illustrative process 500 for recognizing speech segments using trained acoustic models. In addition to acoustic model training, i-vector based approaches may be applied to the speech recognition stage. At 502, a speech data may be received by a speech recognition system, which may include the training data clustering module 104 and a recognition module. At least a part of the speech recognition system may be implemented as a cloud-type application that queries, analyzes, and manipulates returned results from web services, and causes recognition results to be presented on a computing device. In some embodiments, at least a part of the speech recognition may be implemented by a web application that runs on a consumer device.

At 504, the recognition module may generate multiple speech segments based on the speech data. At 506, the recognition module may extract an i-vector from each speech segment of the multiple segments.

At 508, the recognition module may select one or more clusters based on the extracted i-vector. In some embodiments, the selection may be performed based on similarities between the clusters and the extracted i-vector. For example, the recognition module may classify each extracted i-vector to one or more clusters with the nearest centroids. Using the one or more clusters, one or more acoustic conditions (e.g., acoustic models) may be determined. In some embodiments, the recognition module may select a pre-trained linear transform for feature transformation based on the acoustic condition classification result.

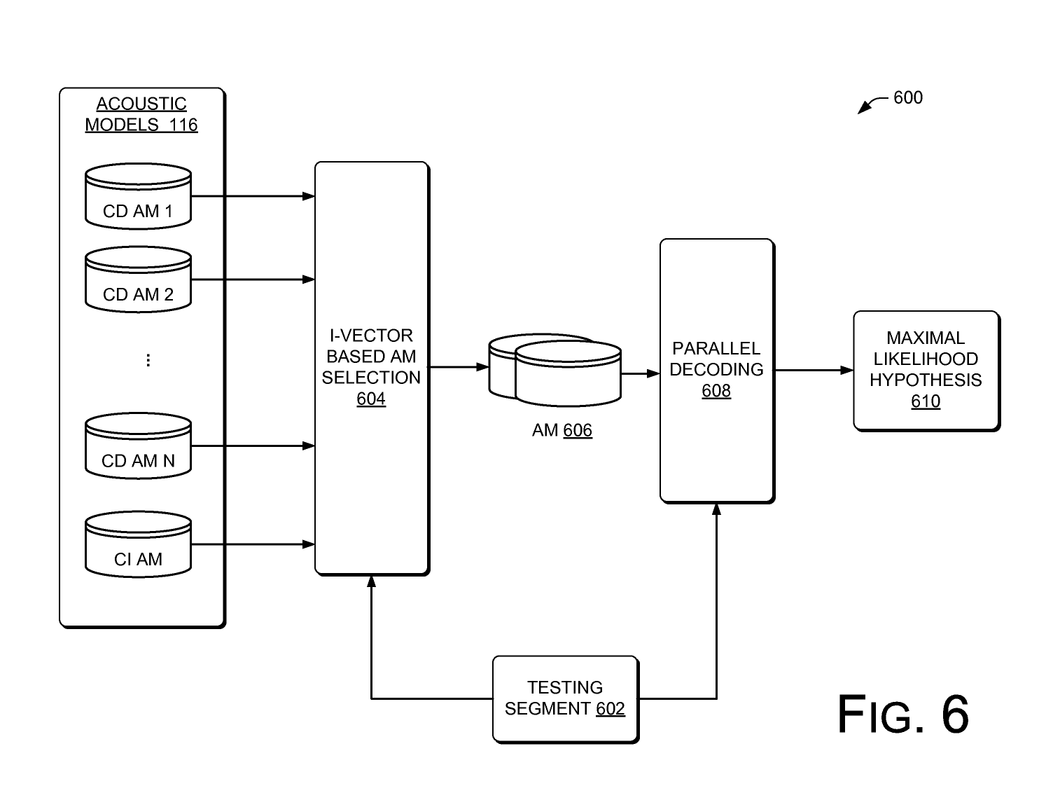

At 510, the recognition module may recognize the speech segment using the one or more determined acoustic models, which is discussed in a greater detail in FIG. 6.

### Illustrative Speech Recognition

FIG. 6 is a schematic diagram of an illustrative scheme 600 that implements speech recognition using one or more acoustic models. The scheme 600 may include the acoustic models 116 and a testing segment 602. The acoustic models 116 may include multiple cluster-dependent acoustic models (e.g., CD AM 1, CD AM 2 . . . CD AM N) and a cluster-independent acoustic model (e.g., CI AM). In some embodiments, the multiple cluster-dependent acoustic models may be trained using the cluster-independent acoustic model as a seed. In these instances, the cluster-independent acoustic model may be trained using all or a portion of training data that generates the cluster-dependent acoustic models.

If a cosine similarity measure is used to cluster the testing segment 602 or an unknown speech segment, then an i-vector may be extracted and normalized to have a unit norm. In some embodiments, a Euclidean distance is used as a dissimilarity measure. After extracting the i-vector, the recognition system may perform i-vector based AM selection 604 to identify AM 606. The AM 606 may represent one or more acoustic models that are trained by a predetermined number of clusters, and that may be used for speech recognition. The predetermined number of clusters may be more similar to the extracted i-vector than to the remaining clusters of the acoustic models 116. For example, the recognition system may compare the extracted i-vector with the centroids associated with the acoustic models 116 including both the cluster-dependent and the cluster-independent acoustic model. The unknown speech segment may be recognized by using the predetermined number of selected cluster-dependent acoustic models and/or cluster-independent acoustic model via parallel decoding 608. In these instances, the final recognition result may be the one with a higher likelihood score under the maximal likelihood hypothesis 610.

In some embodiments, the recognition system may select a cluster that is similar to the extracted i-vector based on, for example, an Euclidean distance or a cosine measure, or based on another dissimilarity metric. Based on the cluster, the recognition system may identify the corresponding cluster-dependent acoustic model and recognize the unknown speech segment using the identified corresponding cluster-dependent acoustic model. In some embodiments, the recognition system may recognize the unknown speech segment using both the corresponding cluster-dependent acoustic model and the cluster-independent acoustic model.

In some embodiments, the parallel decoding 608 may be implemented by using multiple (e.g., partial or all) cluster-dependent acoustic models of the acoustic models 116 and by selecting the final recognition results with likelihood score(s) that exceed a certain threshold, or by selecting the final recognition results with the highest likelihood score(s). In some embodiments, the parallel decoding 608 may be implemented by using multiple (e.g., partial or all) cluster-dependent acoustic models of the acoustic models 116 as well as the cluster-independent acoustic model and selecting the final recognition result with the highest likelihood score(s) (or with scores that exceed a certain threshold).

Illustrative i-Vector Extraction I

“Baum-Welch” statistics are used in conventional i-vector based speaker recognition, but the theoretical justification and derivation provided for conventional technologies cannot be used to justify using hyperparameter estimation in speech recognition. The following describes hyperparameter estimation procedures that justify i-vector based approaches in training data clustering and speech recognition.

Suppose a set of training data that may be denoted as [symbol] ={Yᵢ|i=1,2, . . . , I}, wherein Yᵢ=(y₁⁽ⁱ⁾,y₂⁽ⁱ⁾, . . . , y_{T}_{ᵢ}⁽ⁱ⁾) is a sequence of D-dimensional feature vectors extracted from the i-th training speech segment. From [symbol] , a GMM may be trained using a maximum likelihood (ML) approach to serve as a UBM, as shown in Equation (1).

p(y)=Σₖ₌₁^{K}cₖ [symbol] ₍y; mₖ, Rₖ) (1)

wherein cₖ's are mixture coefficients, [symbol] (·; mₖ, Rₖ) is a normal distribution with a D-dimensional mean vector mₖ and a D×D diagonal covariance matrix Rₖ. M₀ denotes the (D·K)-dimensional supervector by concatenating the mₖ's, and R₀ denotes the (D·K)×(D·K) block-diagonal matrix with Rₖ as its k -th block component. Ω={cₖ, mₖ, Rₖ|k=1, . . . , K} may be used to denote the set of UBM-GMM parameters.

Given a speech segment Yᵢ, a (D·K) -dimensional random supervector M(i) may be used to characterize its variability independent of linguistic content, which relates to M₀ as shown in Equation (2).

M(i)=M₀+Tw(i) (2)

wherein T is a fixed but unknown (D·K)×F rectangular matrix of low rank (i.e., F=(D·K)), and w(i) is an F-dimensional random vector having a prior distribution of standard normal distribution [symbol] (·; 0, I). T may also be called the total variability matrix.

Given Yᵢ, Ω, and T, the i-vector may be the solution of the following problem, as shown in Equations (3) and (4).

$$\begin{matrix}\hat{w} ( i ) = {argmax}_{w ( i )} {\prod }_{t = 1}^{{T}_{i}} {\prod }_{k = 1}^{K} {𝒩 ( {y}_{t}^{( i )} ; {M}_{k} ( i ) , {R}_{k} )}^{P ( k \vert {y}_{t}^{( i )} , Ω )} p ( w ( i ) ) & ( 3 ) \\ P ( k \vert {y}_{t}^{( i )} , Ω ) = \frac{{c}_{k} 𝒩 ( {y}_{t}^{( i )} ; {m}_{k} , {R}_{k} )}{{\sum }_{l = 1}^{K} {c}_{l} 𝒩 ( {y}_{t}^{( i )} ; {m}_{l} , {R}_{l} )} & ( 4 )\end{matrix}$$

wherein Mₖ(i) is the k-th D-dimensional subvector of M(i).

The closed-form solution of the above problem may give the i-vector extraction formula as shown in Equations (5) and (6).

ŵ(i)=I⁻¹(i)T^{T}R₀⁻¹Γ_{y}(i) (5)

l(i)=I+T^{T}Γ(i)R₀⁻¹T (6)

In the above equations, Γ(i) is a (D·K)×(D·K) block-diagonal matrix with γₖ(i)I_{D×D} as its k -th block component; Γ_{y}(i) is a (D·K)-dimensional supervector with Γ_{y,k}(i) as its k-th D-dimensional subvector. The “Baum-Welch” statistics γₖ(i) and Γ_{y,k}(i) may be calculated, as shown in Equations (7) and (8).

$$\begin{matrix}{γ}_{k} ( i ) = {\sum }_{t = 1}^{{T}_{i}} P ( k \vert {y}_{t}^{( i )} , Ω ) & ( 7 ) \\ {Γ}_{y , k} ( i ) = {\sum }_{t = 1}^{{T}_{i}} P ( k \vert {y}_{t}^{( i )} , Ω ) ( {y}_{t}^{( i )} - {m}_{k} ) & ( 8 )\end{matrix}$$

Given the training data y and the pre-trained UBM-GMM Ω, the set of hyperparameters (i.e., total variability matrix) T may be estimated by maximizing the following objective function, as shown in Equation (9).

[symbol]

(T)=Πᵢ₌₁^{l}∫p(Yᵢ|M(i)p(M(i)|T)dM(i) (9)

In some embodiments, a variational Bayesian approach may be used to solve the above problem. In some embodiments, for simplicity, the following approximation may be used to ease the problem:

$$p ( {Y}_{i} \vert M ( i ) ) ≅ {\prod }_{t = 1}^{{T}_{i}} {\prod }_{k = 1}^{K} {𝒩 ( {y}_{t}^{( i )} ; {M}_{k} ( i ) , {R}_{k} )}^{P ( k \vert {y}_{t}^{( i )} , Ω )}$$

In some embodiments, an EM-like algorithm may be used to solve the above simplified problem. The procedures for estimating T may include initialization, E-step, M-step, and repeat/stop.

In the initilization, the initial value of each element in T may be set randomly from [Th₁,Th₂], where Th₁ and Th₂ are two control parameters (Th₁=0,Th₂=0.01 based on experiments). For each training speech segment, the corresponding “Baum-Welch” statistics are calculated as in Equations (7) and (8).

In the E-step, for each training speech segment Yᵢ, the posterior expectation of w(i) may be calcuated using the sufficient statistics and the current estimation of T as shown below:

E[w(i)]=1⁻¹(i)T^{T}R₀⁻¹Γ_{y}(i)

E[w(i)w^{T}(i)]=E[w(i)]E[w^{T}(i)]+l⁻¹(i)

where l(i) is defined in Equation (6).

In M-step, T may be updated using Equation (10) below.

Σᵢ₌₁^{l}Γ(i)TE[w(i)w^{T}(i)]=Σᵢ₌₁^{l}Γ(i)E[w^{T}(i)] (10)

In repeat/stop, E-step and M-step may be repeated for a fixed number of iterations or until the objective function in Equation (9) converges.

Illustrative i-Vector Extraction II

The data model is the same as described in illustrative i-Vector Extraction I, as discussed above.

Given a speech segment Yᵢ, a (D·K)-dimensional random supervector M(i) may be used to characterize its variability independent of linguistic content, which relates to M₀ according to the following full factor analysis model, as shown in Equation (11).

$$\{ \begin{matrix}M ( i ) = {M}_{0} + Tw ( i ) + ɛ ( i ) , \\ w ( i ) \sim 𝒩 ( . ; 0 , I ) , ɛ ( i ) \sim 𝒩 ( . ; 0 , Ψ ) ,\end{matrix} \qquad ( 11 )$$

wherein T is a fixed but unknown (D·K)×F rectangular matrix of low rank (i.e., F=(D·K)), w(i) is an F-dimensional random vector, ε(i) is a (D·K)-dimensional random vector, and ψ=diag{Ψ₁, ψ₂, . . . , Ψ_{DK}} is a positive definite diagonal matrix. In some embodiments, a residual term ε may be added to model the variabilities not captured by the total variability matrix T.

Given Yᵢ, Ω, T and Ψ, the i-vector is defined as the solution of the optimization problem, as shown in Equation (12).

ŵ(i)=argmax_{w(i)}Πₜ₌₁^{T}^{ᵢ}Πₖ₌₁^{K} [symbol] (yₜ⁽ⁱ⁾; Mₖ(i),Rₖ)^{P(k|y}^{ₜ}^{,Ω)}p(w(i)) (12)

wherein Mₖ(i) is the k-th D-dimensional subvector of M(i), and P(k|yₜ⁽ⁱ⁾, Ω) is calculated using Equation (4). The closed-form solution of the above problem may give the i-vector extraction formula, as shown in Equations (13), (14) and (15).

ŵ(i)=ζ⁻¹T^{T}γ^{'11}Ψ⁻¹R₀⁻¹Γ_{y}(i) (13)

ζ=(I+T^{T}(Ψ+Γ(i)⁻¹R₀)⁻¹T)⁻¹ (14)

γ=Γ(i)R₀⁻¹+Ψ⁻¹ (15)

In the above equations, Γ(i) is a (D·K)×(D·K) block-diagonal matrix with γₖ(i)I_{D×D} as its k-th block component; Γ_{y}(i) is a (D·K)-dimensional supervector with Γ_{y,k}(i) as its k-th D-dimensional subvector. The “Baum-Welch” statistics γₖ(i) and Γ_{y,k}(i) may be calculated as in Equations (7) and (8) respectively.

Given the training data y and the pre-trained UBM-GMM Ω, the hyperparameters T and Ψ may be estimated by maximizing the following objective function, as shown in Equation (16).

[symbol]

(T, Ψ)=Πᵢ₌₁^{I}∫p(Yᵢ|M(i)p(M(i)|T, Ψ)dM(i) (16)

In some embodiments, a variational Bayesian approach may be used to solve the above problem. In some embodiments, the following approximation may be used to ease the problem:

$$p ( {Y}_{i} \vert M ( i ) ) ≅ {\prod }_{t = 1}^{{T}_{i}} {\prod }_{k = 1}^{K} {𝒩 ( {y}_{t}^{( i )} ; {M}_{k} ( i ) , {R}_{k} )}^{P ( k \vert {y}_{t}^{( i )} , Ω )}$$

In some embodiments, an EM-like algorithm can be used to solve the above simplified problem. The procedure for estimating T and Ψ may include initialization, E-step, M-step and repeat/stop.

In initializaiton, the initial value of each element in T may be set randomly from [Th₁, Th₂] and the initial value of each element in Ψ randomly from [Th₃, Th₄]+Th₅, where Th₁, Th₂, Th₃>0, Th₄>0, and Th₅>0 are five control parameters. In some embodiments, these thresholds are set as Th₁=Th₃=0, Th₂=Th₄=0.01, Th₅=0.001 under the guidance of the dynamic range of the variance values in UBM-GMM. In some embodiments, the initial values may be set less than a predetermined value because too large initial values may lead to numerical problems in training T. For each training speech segment, calculate the corresponding “Baum-Welch” statistics as in Equations (7) and (8).

In E-step, for each training speech segment Yᵢ, the posterior expectation of the relevant terms may be calculated using the sufficient statistics and the current estimation of T and Ψ as follows:

E[w(i)]=ζ⁻¹T^{T}γ⁻Ψ⁻¹R₀⁻¹Γ_{y}(i)

E[ε(i)]=γ⁻¹(−β^{T}ζ⁻¹T^{T}γ⁻¹Ψ⁻¹+I)R₀⁻Γ_{y}(i)

E[w(i)w(i)^{T}]=E[w(i)]E[w(i)^{T}]+ζ⁻¹

E[ε(i)ε(i)^{T}]=E[ε(i)]E[ε(i)^{T}]+γ⁻¹(I+β^{T}ζ⁻¹βγ⁻¹)

E[ε(i)w(i)^{T}]=E[ε(i)]E[w(i)^{T}]−γ⁻¹β^{T}ζ⁻¹

where ζ and γ are defined in Equations (14) and (15), and β is defined in Equation (17), which is shown below.

β=T^{T}R₀⁻¹Γ(i) (17)

In M-step, Ψ may be updated directly using Equation (18) and T may be updated by solving the Equation (19).

$$\begin{matrix}Ψ = \frac{1}{I} {\sum }_{i = 1}^{I} E [ ɛ ( i ) {ɛ ( i )}^{T} ] & ( 18 ) \\ {\sum }_{i = 1}^{I} Γ ( i ) TE [ w ( i ) {w ( i )}^{T} ] = {\sum }_{i = 1}^{I} ( {Γ}_{y} ( i ) E [ {w ( i )}^{T} ] - Γ ( i ) E [ ɛ ( i ) {w ( i )}^{T} ] ) & ( 19 )\end{matrix}$$

In repeat/stop, the E-step and M-step may repeat for a fixed number of iterations or until the objective function in Equation (16) converges.

Illustrative i-Vector Based Data Clustering

For a training corpus, an i-vector can be extracted from each training speech segment. Given the set of training i-vectors, a hierarchical divisive clustering algorithm (e.g, a Linde-Buzo-Gray (LBG) algorithm) may be to cluster them into multiple clusters. In some embodiments, a Euclidean distance may be used to measure the dissimilarity between two i-vectors, ŵ(i) and ŵ(j). In some embodiments, a cosine measure may be used to measure the similarity between two i-vectors. In these instances, each i-vector may be normalized to have a unit norm so that the following cosine similarity measure can be used, as shown in Equation (20).

sim(ŵ(i), ŵ(j))=ŵ(i)^{T}ŵ(j) (20)

Given the above cosine similarity measure, the centroid, c^{(w)}, of a cluster consisting of n unit-norm vectors, ŵ(1), ŵ(2), . . . , ŵ(n), can be calculated, as shown in Equation (21).

$${c}^{( w )} = {argmax}_{c} {\sum }_{i = 1}^{n} sim ( \hat{w} ( i ) , c ) = \{ \begin{matrix}\frac{{\sum }_{i = 1}^{n} \hat{w} ( i )}{‖ {\sum }_{i = 1}^{n} \hat{w} ( i ) ‖} & if {\sum }_{i = 1}^{n} \hat{w} ( i ) \neq 0 \\ 0 & otherwise\end{matrix} \qquad ( 21 )$$

After the convergence of the LBG clustering algorithm, E clusters of i-vectors with their centroids denoted as c₁^{(w), c}₂^{(w)}, . . . , c_{E}^{(w)} may be obtained respectively, wherein c₀^{(w)} denotes the centroid of all the training i-vectors.

### Illustrative Recognition Using Multiple Acoustic Models

After clustering, each training speech segment may be classified into one of E clusters. For each cluster, a cluster-dependent acoustic model may be trained by using a cluster-independent acoustic model as a seed. Consequently, there will be E cluster-dependent acoustic models and one cluster-independent acoustic model. Such trained multiple acoustic models may be used in the recognition stage to improve recognition accuracy.

In some embodimetns, for an unknown speech segment Y, an i-vector may be extracted first. The i-vector may be normalized to have a unit norm if cosine similarity measure is used.

If an Euclidean distance is used as a dissimilarity measure, Y may be classified to a cluster, e, as shown in Equation (22).

e=argmin_{l=1,2, . . . ,E}EuclideanDistance(ŵ,cₗ^{(w)}) (22)

If a cosine similarity measure is used, Y may be classified to a cluster, e, as shown in Equation (23).

e=argmax_{l=1,2, . . . ,E}sim(ŵ,cₗ^{(w)}) (23)

The cluster-dependent acoustic model of the e-th cluster will be used to recognize Y. This is a more efficient way to use multiple cluster-dependent acoustic models.

In some embodiments, Y will be recognized by using both the selected cluster-dependent acoustic model and the cluster-independent acoustic model via parallel decoding. The final recognition result will be the one with a higher likelihood score.

In some embodiments, i-vector based cluster selection may be implemented by comparing ŵ with E+1 centroids, namely c₀^{(w)}, c₁^{(w)}, c₂^{(w)}, c_{E}^{(w)}, to identify top L most similar clusters. Y may be recognized by using the L selected (e.g., cluster-dependent and/or cluster-independent) acoustic models via the parallel decoding.

In some embodiments, the parallel decoding may be implemented by using E cluster-dependent acoustic models, and the final recognition result with the highest likelihood score may be selected.

In some embodimetns, the parallel decoding may be implemented by using E cluster-dependent acoustic models and one cluster-independent acoustic model, and the final recognition result with the highest likelihood score may be selected.

### Illustrative Computing Device

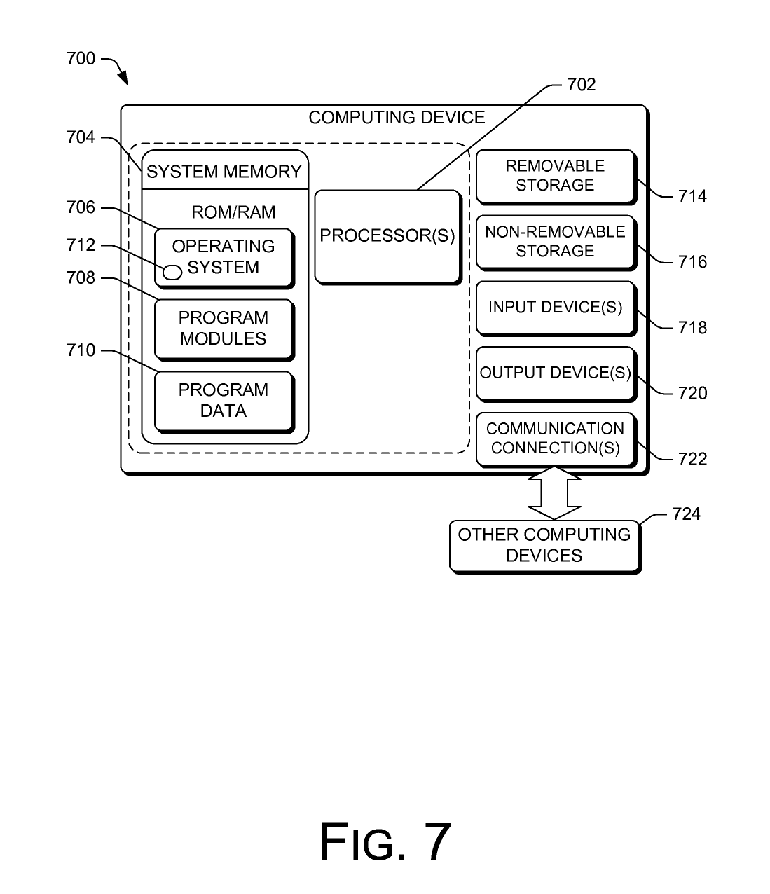

FIG. 7 shows an illustrative computing device 700 that may be used to implement the speech recognition system, as described herein. The various embodiments described above may be implemented in other computing devices, systems, and environments. The computing device 700 shown in FIG. 7 is only one example of a computing device and is not intended to suggest any limitation as to the scope of use or functionality of the computer and network architectures. The computing device 700 is not intended to be interpreted as having any dependency or requirement relating to any one or combination of components illustrated in the example computing device.

In a very basic configuration, the computing device 700 typically includes at least one processing unit 702 and system memory 704. Depending on the exact configuration and type of computing device, the system memory 704 may be volatile (such as RAM), non-volatile (such as ROM, flash memory, etc.) or some combination of the two. The system memory 704 typically includes an operating system 706, one or more program modules 708, and may include program data 710. For example, the program modules 708 may include the training data clustering module 104 and the recognition module, as discussed in the illustrative operation.

The operating system 706 includes a component-based framework 712 that supports components (including properties and events), objects, inheritance, polymorphism, reflection, and the operating system 706 may provide an object-oriented component-based application programming interface (API). Again, a terminal may have fewer components but will interact with a computing device that may have such a basic configuration.

The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 714 and non-removable storage 716. Computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. The system memory 704, the removable storage 714 and the non-removable storage 716 are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other non-transmission medium that can be used to store the desired information and which can be accessed by the computing device 700. Any such computer storage media may be part of the computing device 700. Moreover, the computer-readable media may include computer-executable instructions that, when executed by the processor(s) 702, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media.

The computing device 700 may also have input device(s) 718 such as keyboard, mouse, pen, voice input device, touch input device, etc. Output device(s) 720 such as a display, speakers, printer, etc. may also be included. These devices are well known in the art and are not discussed at length here.

The computing device 700 may also contain communication connections 722 that allow the device to communicate with other computing devices 724, such as over a network. These networks may include wired networks as well as wireless networks. The communication connections 724 are one example of communication media.

It is appreciated that the illustrated computing device 700 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like. For example, some or all of the components of the computing device 700 may be implemented in a cloud computing environment, such that resources and/or services are made available via a computer network for selective use by mobile devices.

### CONCLUSION

Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A computer-implemented method for clustering training data in speech recognition, the method comprising:
extracting a plurality of i-vectors from speech data including a plurality of speech segments;
clustering the plurality of i-vectors into a plurality of clusters;
training an acoustic model using one of the plurality of clusters; and
recognizing one or more other speech segments using the trained acoustic model.

2. The computer-implemented method as recited in claim 1, wherein
the extracting the plurality of i-vectors from the speech data comprises:
training a Gaussian mixture model (GMM) to represent the speech data;
calculating a set of hyperparameters based on the speech data; and
extracting the plurality of i-vectors based on the GMM and the set of hyperparameters.

3. The computer-implemented method as recited in claim 2, wherein
the calculating the set of hyperparameters comprises:
initializing the set of hyperparameters;
calculating statistics corresponding to the plurality of speech segments;
calculating a posterior expectation associated with the speech data using:
the one or more corresponding statistics, and
the set of hyperparameters; and
updating the set of hyperparameters based on the posterior expectation to generate an updated set of hyperparameters, wherein the extracting the i-vector is further based on the updated set of hyperparameters.

4. The computer-implemented method as recited in claim 2, further comprising:
calculating an additional set of hyperparameters using a residual term to model variabilities associated with the speech data that are not captured by the set of hyperparameters, and wherein the extracting the i-vector is further based on the additional set of hyperparameters.

5. The computer-implemented method as recited in claim 1, wherein a similarity between two i-vectors of the plurality of i-vectors is measured using one of a Euclidean distance or a cosine measure.

6. The computer-implemented method as recited in claim 1, wherein the acoustic model is cluster-dependent and trained based on a cluster-independent acoustic model that is trained using speech data.

7. The computer-implemented method as recited in claim 6, wherein the recognizing the one or more speech segments using the trained acoustic model comprises recognizing the one or more speech segments using the cluster-dependent acoustic model and the cluster-independent acoustic model.

8. The computer-implemented method as recited in claim 1, further comprising:
receiving other speech data;
generating the one or more other speech segments based on the other speech data;
extracting an i-vector from one segment of the one or more other speech segments;
selecting a cluster corresponding to the i-vector; and
determining an acoustic model that is trained by the cluster, and wherein the recognizing the one or more other speech segments using the trained acoustic model comprises recognizing the one segment using the acoustic model.

9. A method comprising:
under control of one or more computing systems comprising one or more processors,
receiving speech data including a plurality of speech segments;
extracting an i-vector from a speech segment of the plurality of speech segments;
selecting a cluster corresponding to the i-vector; and
determining an acoustic model corresponding to the cluster; and
recognizing the speech segment using the acoustic model.

10. The method as recited in claim 9, further comprising:
extracting a plurality of i-vectors from a plurality of training speech segments;
clustering the plurality of i-vectors into multiple clusters that includes the cluster; and
training acoustic models using the multiple clusters, the acoustic models including the acoustic model.

11. The method as recited in claim 10, wherein the extracting the plurality of i-vectors from the plurality of training speech segments comprises:
training a GMM based on the plurality of training speech segments;
calculating hyperparameters of the plurality of training speech segments;
calculating additional hyperparameters to model variabilities of the plurality of training speech segments not captured by the hyperparameters; and
extracting the plurality of i-vectors based on the GMM, the hyperparameters and the additional hyperparameters.

12. The method as recited in claim 9, wherein the selecting the cluster corresponding to the i-vector comprises:
normalizing the i-vector using a cosine similarity measure; and
selecting the cluster based on a similarity between the i-vector and a centroid of the cluster.

13. The method as recited in claim 12, wherein the selecting the cluster comprises selecting multiple clusters based on similarities between the i-vector and centroids of the multiple clusters, and wherein the determining the acoustic model corresponding to the cluster comprises determining multiple acoustic models corresponding to the multiple clusters.

14. The method as recited in claim 9, wherein the determining the acoustic model comprises determining a cluster-dependent acoustic model and a cluster-independent acoustic model, and wherein the cluster-dependent acoustic model is trained based on the cluster-independent acoustic model.

15. One or more computer-readable media storing instructions that are executable by one or more processors to perform acts comprising:
receiving a plurality of training speech segments;
extracting multiple i-vectors from the plurality of training speech segments based on a set of hyperparameters of the plurality of training speech segments, individual ones of the i-vectors of the multiple i-vectors corresponding to a training speech segment of the plurality of training speech segments;
clustering the i-vectors into multiple clusters;
training a cluster-dependent acoustic model using a cluster of the multiple clusters; and
recognizing an unknown speech segment using the cluster-dependent acoustic model.

16. The one or more computer-readable media as recited in claim 15, wherein an i-vector extracted from the unknown speech segment is associated with a cluster corresponding to the cluster-dependent acoustic model.

17. The one or more computer-readable media as recited in claim 15, wherein the extracting multiple i-vectors comprises extracting multiple i-vectors further based on an additional set of hyperparameters that model variabilities of the plurality of training speech segments not captured by the set of hyperparameters.

18. The one or more computer-readable media as recited in claim 15, wherein the set of hyperparameters are determined based on Baum-Welch statistics that correspond to the plurality of training speech segments and a GMM that is trained to represent the plurality of training speech segments.

19. The one or more computer-readable media as recited in claim 15, wherein the clustering the i-vectors into multiple clusters comprises clustering the i-vectors into multiple clusters using a Linde-Buzo-Gray (LBG) algorithm.

20. The one or more computer-readable media as recited in claim 15, wherein a similarity between two i-vectors of the multiple i-vectors is measured using one of a Euclidean distance or a cosine measure.
